(19) United States
(12) Patent Application Publication
(10) Pub. No.: US 2014/0080409 A1
(43) Pub. Date: Mar. 20, 2014

(54) STATIC TUNING OF WIRELESS TRANSMITTERS

(71) Applicants: Stephen Frankland, Farnborough (GB); Terence Legge, Farnborough (GB)

(72) Inventors: Stephen Frankland, Farnborough (GB); Terence Legge, Farnborough (GB)

(73) Assignee: QUALCOMM INCORPORATED, San Diego, CA (US)

(21) Appl. No.: 13/621,762

(22) Filed: Sep. 17, 2012

(51) Int. Cl. H04B 5/00

(52) U.S. Cl. CPC H04B 5/0037
USPC 455/41.1

(57) ABSTRACT

A method and device for static tuning of wireless transmitters is disclosed. In some aspects, the antenna circuit can be located on a circuit board and configured to generate a wireless field and resonate at a resonant frequency. A tuning signal is applied an antenna circuit to drive the antenna circuit. A signal of the resonant frequency of the antenna circuit is detected and an adjustment value is determined based on the detected signal. A reactance of a variable reactance component is adjusted based on the adjustment value to maintain the resonant frequency in a range between a first frequency that is less than the detected resonant frequency and a second frequency that is greater than the detected resonant frequency.

### FIELD

The disclosure is directed to methods and systems for static tuning of a wireless transmitter.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a functional block diagram of an exemplary wireless power transfer system, in accordance with implementations of the invention.

FIG. 2 is a functional block diagram of exemplary components that may be used in the wireless power transfer system of FIG. 1, in accordance with various implementations of the invention.

FIG. 3 is a schematic diagram of a portion of transmit circuitry or receive circuitry of FIG. 2 including a transmit or receive antenna, in accordance with implementations of the invention.

FIG. 4 is a functional block diagram of a transmitter that may be used in the wireless power transfer system of FIG. 1, in accordance with implementations of the invention.

FIG. 5 is a functional block diagram of a receiver that may be used in the wireless power transfer system of FIG. 1, in accordance with implementations of the invention.

FIG. 6 is a schematic diagram of a portion of transmit circuitry that may be used in the transmit circuitry of FIG. 4.

FIG. 7 illustrates an antenna circuit that is integrated on a circuit board and a calibration circuit according to some implementations.

FIG. 8 illustrates an antenna circuit that is integrated on a circuit board and a calibration circuit according to some implementations.

FIG. 9 is a flowchart of an exemplary method for adjusting the reactance of one variable reactance component.

FIG. 10 is a flowchart of another exemplary method for adjusting the reactance of one variable reactance component.

FIG. 11 is a functional block diagram of a device according to some implementations.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary implementations of the invention and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer. The power output level and transfer efficiency are sufficient to charge a load (such as a rechargeable battery, or the like) of a receiving device.

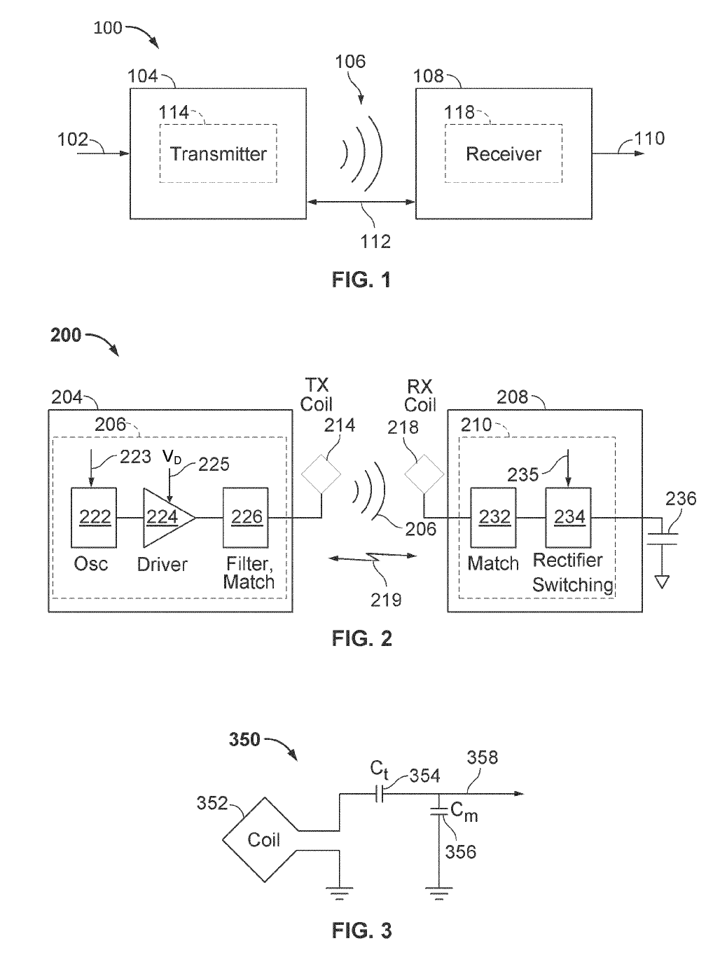

FIG. 1 is a functional block diagram of an exemplary wireless power transfer system 100, in accordance with exemplary implementations of the invention. Input power 102 may be provided to a transmitter 104 from a power source (not shown) for generating a field 105 for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary implementation, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are minimal. As such, wireless power transfer may be provided over larger distance in contrast to purely inductive solutions that may require large coils that require coils to be very close (e.g., mms). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 105. In some cases, the field 105 may correspond to the “near-field” of the transmitter 104 as will be further described below. The transmitter 104 may include a transmit antenna 114 for outputting an energy transmission. The receiver 108 further includes a receive antenna 118 for receiving or capturing energy from the energy transmission. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114. The transmit and receive antennas 114 and 118 are sized according to applications and devices to be associated therewith. As described above, efficient energy transfer may occur by coupling a large portion of the energy in a field 105 of the transmit antenna 114 to a receive antenna 118 rather than propagating most of the energy in an electromagnetic wave to the far field. When positioned within the field 105, a “coupling mode” may be developed between the transmit antenna 114 and the receive antenna 118. The area around the transmit and receive antennas 114 and 118 where this coupling may occur is referred to herein as a coupling-mode region.

FIG. 2 is a functional block diagram of exemplary components that may be used in the wireless power transfer system 100 of FIG. 1, in accordance with various exemplary implementations of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the transmit antenna 214.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive antenna 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 206.

As described in greater detail below, receiver 208, which may initially have an associated load (e.g., battery 236) may be configured to determine whether an amount of power transmitted by transmitter 204 and receiver by receiver 208 is appropriate for charging the battery 236. The load (e.g., battery 236) may be configured to be selectively coupled to the receiver 208. Receiver 208 may be configured to enable the load (e.g., battery 236) upon determining that the amount of power is appropriate. In some implementations, a receiver 208 may be configured to directly utilize power received from a wireless power transfer field without charging of a battery 236. For example, a communication device, such as a near-field communication (NFC) or radio-frequency identification device (RFID may be configured to receive power from a wireless power transfer field and communicate by interacting with the wireless power transfer field and/or utilize the received power to communicate with a transmitter 204 or other devices.

FIG. 3 is a schematic diagram of a portion of transmit circuitry 206 or receive circuitry 210 of FIG. 2 including a transmit or receive antenna 352, in accordance with exemplary implementations of the invention. As illustrated in FIG. 3, transmit or receive circuitry 350 used in exemplary implementations may include a coil 352. The coil 352 may also be referred to or be configured as a “loop” antenna 352. The coil 352 may also be referred to herein or be configured as a “magnetic” antenna or an induction coil. The term “coil” is intended to refer to a component that may wirelessly output or receive energy for coupling to another “coil.” The coil may also be referred to as an “antenna” of a type that is configured to wirelessly output or receive power. The coil 352 may be configured to include an air core or a physical core such as a ferrite core (not shown). Air core loop coils may be more tolerable to extraneous physical devices placed in the vicinity of the core. Furthermore, an air core loop coil 352 allows the placement of other components within the core area. In addition, an air core loop may more readily enable placement of the receive antenna 218 (FIG. 2) within a plane of the transmit antenna 214 (FIG. 2) where the coupled-mode region of the transmit antenna 214 (FIG. 2) may be more powerful.

As stated, efficient transfer of energy between the transmitter 104 and receiver 108 may occur during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the field 105 of the transmitting antenna to the receiving antenna residing in a region where this field 105 is established rather than propagating the energy from the transmitting antenna into free space.

The resonant frequency of the loop or magnetic antennas is based on the inductance and capacitance. Inductance may be simply the inductance created by the coil 352, whereas, capacitance may be added to the coil's inductance to create a resonant structure at a desired resonant frequency. As a non-limiting example, capacitor 352 and capacitor 354 may be added to the transmit or receive circuitry 350 to create a resonant circuit that selects a signal 356 at a resonant frequency. Accordingly, for larger diameter coils, the size of capacitance needed to sustain resonance may decrease as the diameter or inductance of the loop increases. Furthermore, as the diameter of the coil increases, the efficient energy transfer area of the near-field may increase. Other resonant circuits formed using other components are also possible. As another non-limiting example, a capacitor may be placed in parallel between the two terminals of the antenna 350. For transmit antennas, a signal 358 with a frequency that substantially corresponds to the resonant frequency of the coil 352 may be an input to the coil 352.

In one implementation, the transmitter 104 may be configured to output a time varying magnetic field with a frequency corresponding to the resonant frequency of the transmit antenna 114. When the receiver is within the field 105, the time varying magnetic field may induce a current in the receive antenna 118. As described above, if the receive antenna 118 is configured to be resonant at the frequency of the transmit antenna 118, energy may be efficiently transferred. The AC signal induced in the receive antenna 118 may be rectified as described above to produce a DC signal that may be provided to charge or to power a load.

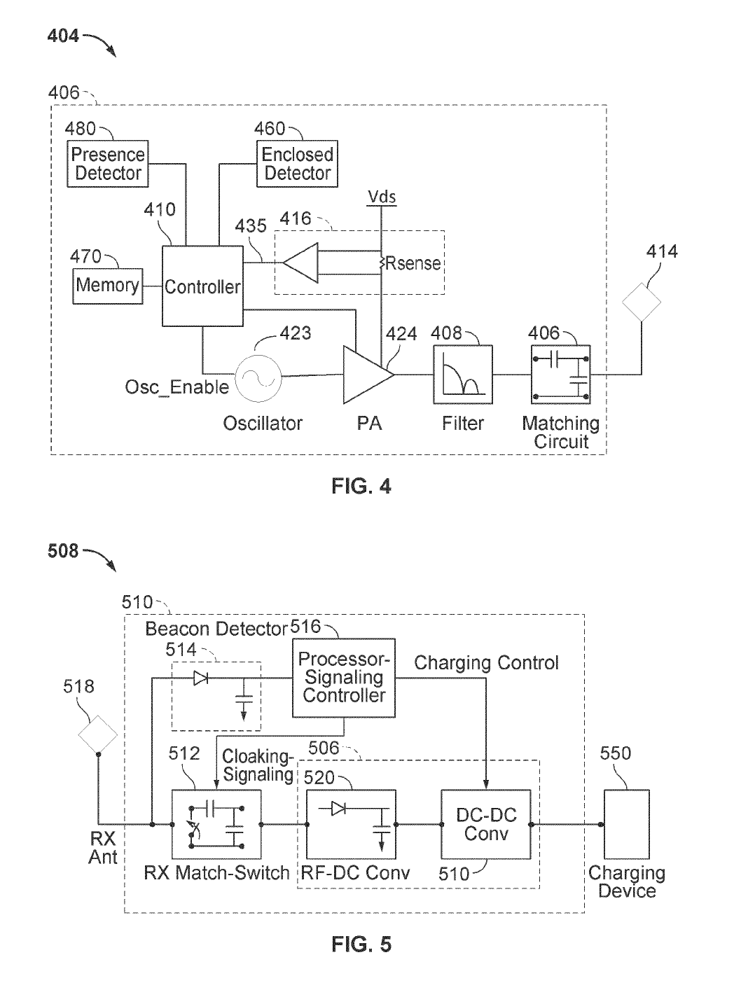

FIG. 4 is a functional block diagram of a transmitter 404 that may be used in the wireless power transfer system of FIG. 1, in accordance with exemplary implementations of the invention. The transmitter 404 may include transmit circuitry 406 and a transmit antenna 414. The transmit antenna 414 may be the coil 352 as shown in FIG. 3. Transmit circuitry 406 may provide RF power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 13.56 MHz ISM band.

Transmit circuitry 406 may include a fixed impedance matching circuit 409 for matching the impedance of the transmit circuitry 406 (e.g., 50 ohms) to the transmit antenna 414 and a low pass filter (LPF) 408 configured to reduce harmonic emissions to levels to prevent self-jamming of devices coupled to receivers 108 (FIG. 1). Other exemplary implementations may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive an RF signal as determined by an oscillator 423. The transmit circuitry 406 may be comprised of discrete devices or circuits, or alternately, may be comprised of an integrated assembly. An exemplary RF power output from transmit antenna 414 may be on the order of 2.5 Watts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as processor 415. Adjustment of oscillator phase and related circuitry in the transmission path may allow for reduction of out-of-band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit antenna 414 may be implemented with a Litz wire or as an antenna strip with the thickness, width and metal type selected to keep resistive losses low. In a one implementation, the transmit antenna 414 may generally be configured for association with a larger structure such as a table, mat, lamp or other less portable configuration. Accordingly, the transmit antenna 414 generally may not need “turns” in order to be of a practical dimension. An exemplary implementation of a transmit antenna 414 may be “electrically small” (i.e., fraction of the wavelength) and tuned to resonate at lower usable frequencies by using capacitors to define the resonant frequency.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the RX device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary implementations, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the electromagnetic field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary implementations, a method by which the transmitter 404 does not remain on indefinitely may be used. In this case, the transmitter 404 may be programmed to shut off after a user-determined amount of time. This feature prevents the transmitter 404, notably the driver circuit 424, from continuing to operate after the wireless devices in its perimeter are fully charged. This event may be due to the failure of the circuit to detect the signal sent from either the repeater or the receive antenna that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a functional block diagram of a receiver 508 that may be used in the wireless power transfer system of FIG. 1, in accordance with exemplary implementations of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (an other medical devices), and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller that the diameter of length of transmit antenna 414. In such an example, receive antenna 518 may be implemented as a multi-turn antenna in order to reduce the capacitance value of a tuning capacitor (not shown) and increase the receive antenna's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting a received RF energy source into charging power for use by the device 550. Power conversion circuitry 506 includes an RF-to-DC converter 520 and may also in include a DC-to-DC converter 522. RF-to-DC converter 520 rectifies the RF energy signal received at receive antenna 518 into a non-alternating power with an output voltage represented by V_{rect}. The DC-to-DC converter 522 (or other power regulator) converts the rectified RF energy signal into an energy potential (e.g., voltage) that is compatible with device 550 with an output voltage and output current represented by Vₒᵤₜ and Tₒᵤₜ. Various RF-to-DC converters are contemplated, including partial and full rectifiers, regulators, bridges, doublers, as well as linear and switching converters.

Receive circuitry 510 may further include switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

As disclosed above, transmitter 404 includes load sensing circuit 416 that may detect fluctuations in the bias current provided to transmitter driver circuit 424. Accordingly, transmitter 404 has a mechanism for determining when receivers are present in the transmitter's near-field.

When multiple receivers 508 are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404 as is explained more fully below. Additionally, a protocol may be associated with the switching that enables the sending of a message from receiver 508 to transmitter 404. By way of example, a switching speed may be on the order of 100 μsec.

In an exemplary implementation, communication between the transmitter 404 and the receiver 508 refers to a device sensing and charging control mechanism, rather than conventional two-way communication (i.e., in band signaling using the coupling field). In other words, the transmitter 404 may use on/off keying of the transmitted signal to adjust whether energy is available in the near-field. The receiver may interpret these changes in energy as a message from the transmitter 404. From the receiver side, the receiver 508 may use tuning and de-tuning of the receive antenna 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations, that may correspond to informational signaling from the transmitter to the receiver. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Cloaking of receiver 508 may also occur upon the occurrence of other events including detection of an external wired charging source (e.g., wall/USB power) providing charging power to device 550. Processor 516, in addition to controlling the cloaking of the receiver, may also monitor beacon circuitry 514 to determine a beacon state and extract messages sent from the transmitter 404. Processor 516 may also adjust the DC-to-DC converter 522 for improved performance.

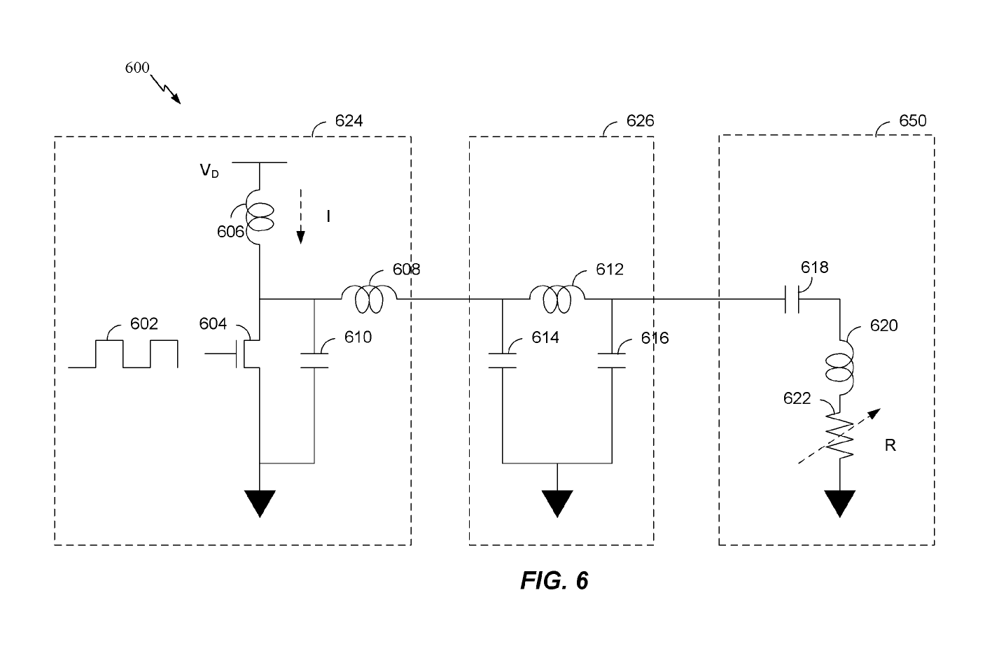

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with implementations of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the coil or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

An antenna circuit is provided separately from a circuit board including the components of the corresponding electronic device. For example, a wireless antenna including a coil may be retrofit to a portion of an electronic device including the battery pack. The retro-fit antenna may be placed on a ferrite backing and be coupled to other circuit components to enable charging of the battery, and/or reception of near field communication (NFC) signals. A retro-fit antenna may be pre-calibrated and pre-tuned based on the known structure of the corresponding electronic device and the placement of the retro-fit antenna. As a result, each retro-fit antenna may be pre-calibrated and pre-tuned according to each particular electronic device.

In some implementations, an antenna circuit may be implemented on a circuit board that is integrated into a plurality of different electronic devices which include different structural configurations. In these implementations, the variation in structure between the different electronic devices may result in variation of the resonant frequency for the same antenna circuit when integrated in different electronic devices. For example, the location of the circuit board including the antenna circuit relative to a battery pack of a first electronic device may be different than the location of the circuit board relative to a battery pack of a second electronic device having different structural specifications (e.g., due to variation in manufacturer, device type, or the like). The variations in resonant frequency may result in differences in performance for antenna circuits that are integrated in different electronic devices.

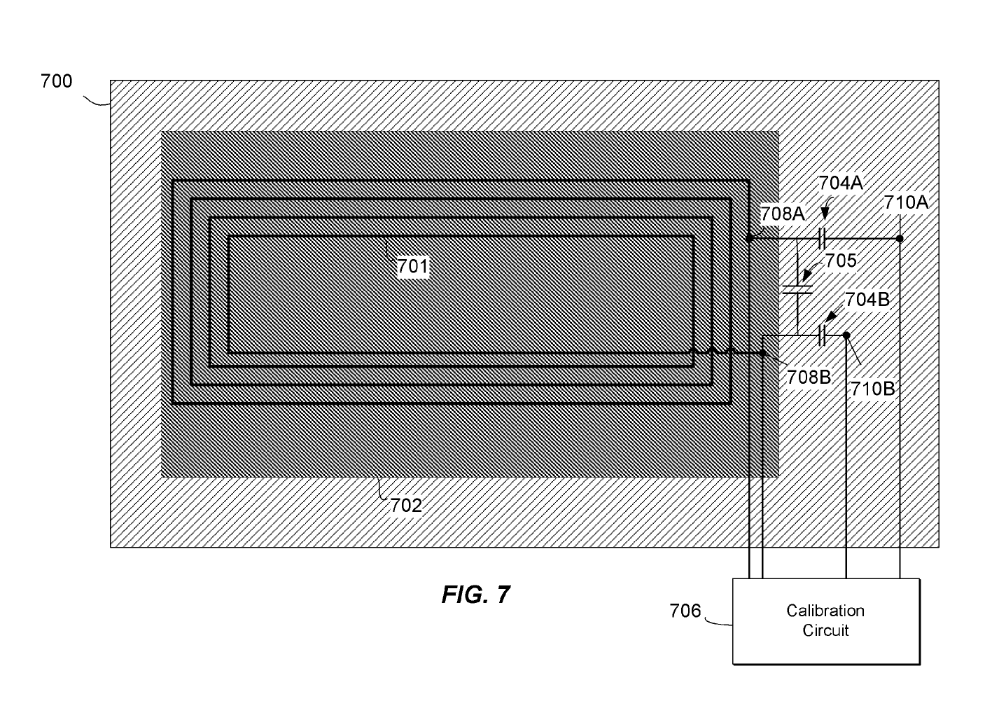

FIG. 7 illustrates an antenna circuit that is integrated on a circuit board and a calibration circuit according to some implementations. As shown in FIG. 7, a ferrite sheet 702 may be placed on a layer of the circuit board 700. A coil 701 is wound in a plane on the circuit board 700 and the ferrite sheet 702. In some implementations, the coil 701 may be provided as an air-core antenna and the ferrite sheet 702 may be removed.

While not show, the circuit board 700 includes other components for integration with an electronic device. For example the circuit board 700 may include a plurality of layers corresponding to different circuits (e.g., processing circuitry) that are configured to be integrated with an electronic device.

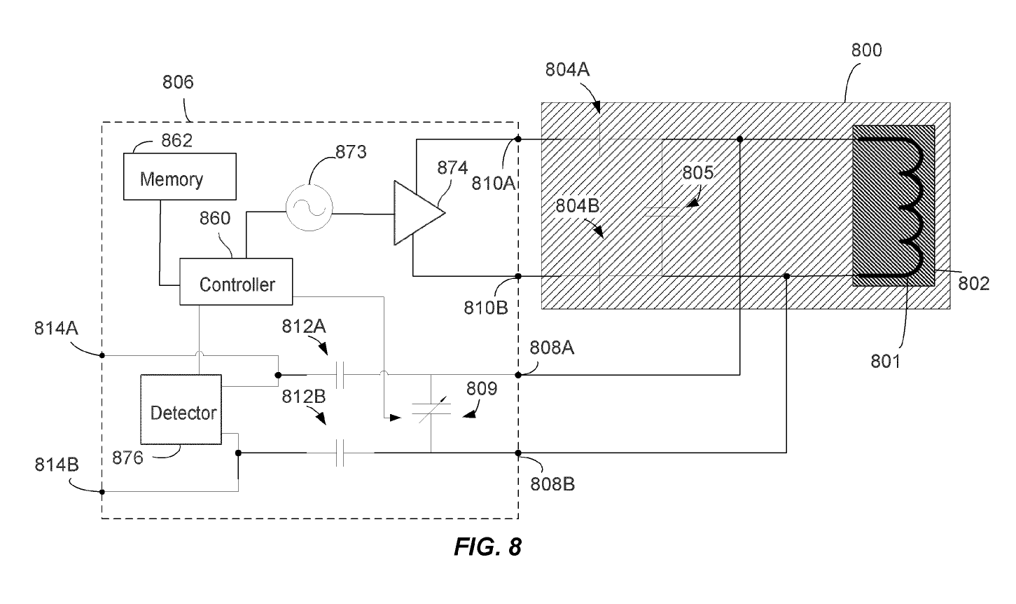

As shown in FIG. 7, the coil 701 is coupled to capacitors 704A, 704B, and 705 which, together with the coil 701 form a resonant antenna having a corresponding LC value and an associated resonant frequency. A calibration circuit 706 is coupled to TX driving terminals 710A and 710B, as well as RX receiving terminals 708A, 708B. The calibration circuit is described in greater detail with reference to FIG. 8 below.

Since the antenna circuit (e.g., coil 701 and capacitors 704A, 704B, and 705) are integrated on the circuit board 700, the performance and response of the antenna circuit may vary based on the structure of a device that houses the circuit board 700. For example, as discussed above, the thickness of the housing of a device and the location of the circuit board 700 relative to other components, such as a battery pack, may change the resonant frequency of the antenna circuit. In some implementations, the calibration circuit 706 is configured to statically tune the antenna circuit in order to maintain a resonant frequency within a predetermined range as will be discussed in greater detail below with reference to FIG. 8.

FIG. 8 illustrates an antenna circuit that is integrated on a circuit board 800 and a calibration circuit 806 according to some implementations. Similar to the antenna circuit of FIG. 7, the antenna circuit shown in FIG. 8 includes capacitors 804A, 804B, 805 and a coil 801 which is illustrated as an equivalent inductor. The coil 801 may be provided on a ferrite sheet 802 as shown in FIG. 8, or may be provided as an air core antenna as discussed above.

The calibration circuit 806 includes a memory 862, a controller 860, an oscillator 873 and a driver 874. The controller 860 is configured to control the oscillator 873 to generate a signal (e.g., a sinusoidal signal) at a driving frequency. The signal from the oscillator 873 is used as an input to the driver 874 to generate a driving signal for driving the antenna circuit through the terminals 810A and 810B. To calibrate the antenna circuit, the controller 860 is configured to adjust the signal that is generated by the oscillator 873 in order to drive the antenna circuit at different frequencies. For example, in some implementations, the oscillator 873 may be controlled by the controller 860 to generate a frequency sweep by outputting signals to the driver at increasing or decreasing frequencies.

The calibration circuit 806 also includes a detector 876, a variable capacitor 809, and tuning capacitors 812A and 812B. The variable capacitor 809 is connected in parallel to a receive path of the antenna circuit at terminals 808A and 808B of the calibration circuit 806 as shown in FIG. 8. As shown in FIG. 8, the variable capacitor 809 is connected in parallel to both the coil 801 and the capacitor 805 of the antenna circuit and a variation in the capacitance of the variable capacitor 809 can be used to adjust the resonant frequency of the antenna circuit by varying the LC constant of the antenna circuit. Further, while illustrated as a variable capacitor 809, the calibration circuit 806 may alternatively include a variable inductor to adjust the LC constant of the antenna circuit.

The detector 876 is coupled to the tuning capacitors 812A and 812B as shown in FIG. 8. The detector 876 may be configured to detect one or more of a current or a voltage along the receive signal path. The calibration circuit 806 is configured to use the RX and TX paths to test the antenna circuit and calibrate the antenna circuit during initial device configuration following integration of the circuit board 800 into the corresponding device. As shown in FIG. 8, the TX path may correspond to a driving signal path (e.g., an NFC RF front-end) that is configured to apply a driving signal to the antenna circuit through input driving terminal 810A, 810B. The RX path may correspond to a tapped location of the antenna circuit that is coupled to, for example, an energy harvesting circuit (not shown). In some implementations, the calibration circuit 806 may be provided as part of the wireless power transmitter (e.g., such as wireless power transmitter 406 as discussed above with reference to FIG. 4).

The calibration circuit 806 may apply a frequency sweep signal and measure a response of the antenna circuit to the frequency sweep signal. The detector 876 may detect one or more of a voltage and a current at the RX path terminals 808A and 808b to determine the response of the antenna circuit to the applied frequency sweep signal. The controller 860 receives the detected voltage or current and may determine an adjustment value based on the detected voltage or current. For example, the controller 860 may be configured to compare the detected voltage or current with a predetermined value that corresponds to resonant operation of the particular antenna circuit. The calibration circuit 806 may then determine the calibration settings based on the comparison of the measured response to the predetermined value, and store the calibration settings in a memory 862. In some implementations, the adjustment values may be pre-stored in the memory 862 based on a particular antenna circuit and/or a particular electronic device (for example by manufacturer product code). The controller 860 may be configured to retrieve the adjustment values for adjusting the variable capacitor 809 based on the stored adjustment values. In some implementations, the controller 860 may be configured to initiate testing of the antenna circuit based on the stored adjustment values in order to derive more accurate adjustment values.

Using the stored calibration settings, the controller 860 may apply the adjustment values to control the capacitance of the variable capacitor 809. For example, the adjustment values may correspond to an incremental adjustment for tuning variable reactance components of the calibration circuit 806, such as variable capacitor 809. Using the adjustment values, the calibration circuit 806 is configured to tune the antenna circuit to be set at a substantially resonant frequency.

In some implementations, the calibration circuit 806 is configured to provide a trimming effect to the antenna circuit such that the resonant frequency of the antenna circuit remains within a predetermined range. The capacitance of the variable capacitor 809 may be set to a value that is substantially greater than variable reactance components that are provided for dynamic tuning by a wireless transmitter. The controller 860 may set the capacitance of the variable capacitor 809 such that the resonant frequency of the antenna circuit is within a range of a detected resonant frequency that is determined by the controller 860 following application of the testing signals. For example, the controller 860 may determine that the resonant frequency of the antenna circuit is 6.78 MHz based on the detected current or voltage during application of a frequency sweep. The controller 860 may then set the capacitance of the variable capacitor 809 such that further adjustment of the antenna circuit (e.g., through dynamic tuning of variable reactance components of a wireless transmitter) is within a window that is centered about the detected resonant frequency of the antenna circuit. For example, dynamic tuning may be provided such that the maximum adjustment during dynamic tuning through the wireless transmitter is within a range of +/−7 KHz of the detected resonant frequency (e.g. 6.78 MHz). The static (e.g., coarse) adjustment provided by the calibration circuit 806 enables further fine adjustment by a wireless power transmitter in order to operate the antenna circuit at the resonant frequency following integration in an electronic device. As a result, multiple antenna circuit designs may be tuned using the calibration circuit 806 to adjust the resonant frequency of the antenna circuit.

In some implementations, the calibration is performed upon initial device configuration, for example, upon device turn-on following integration of the circuit board to the device. Further, scheduling and allocation of on device resources may allow recalibration of systems following the initial calibration of the antenna circuit.

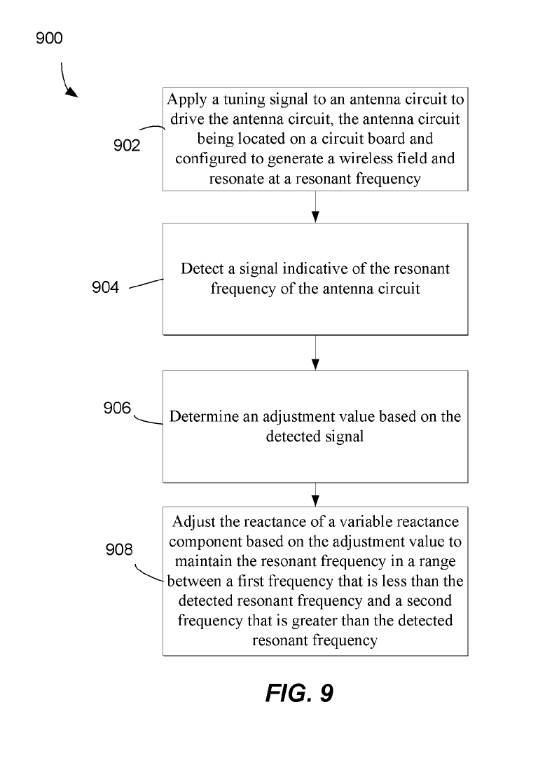

In one embodiment, upon receiving at least one calibration or recalibration request from a system scheduler or any other related and authorized component or module, the calibration device 806 may start a calibration or recalibration process. FIG. 9 is a flowchart that shows an exemplary method 900 for adjusting the reactance of one variable reactance component for calibrating or recalibrating a device. The method a block 902, where the calibration device 806 starts to apply a tuning signal to the antenna circuit 700 and drive the antenna circuit 700. The tuning signal is generated by an oscillator 873 under the control of the controller 860. The antenna circuit 700 may be located on the circuit board 800 and configured to generate a wireless field and resonate at a resonant frequency. FIG. 8 illustrates an example of integrating the antenna circuit 700 into the circuit board 800. After the block 902 of FIG. 9, the detector 876 detects a signal indicative of the resonant frequency of the antenna circuit 700 as shown in a block 904. Next, the detector 876 determines an adjustment value based on the detected signal (block 906). After obtaining the adjustment value, the controller 860 adjusts the reactance of a variable reactance component based on the adjustment value to maintain the resonant frequency in a range between a first frequency that is less than the detected resonant frequency and a second frequency that is greater than the detected resonant frequency as shown in a block 908. After this adjustment is finished by the controller 860, the calibration or recalibration is finished for this request.

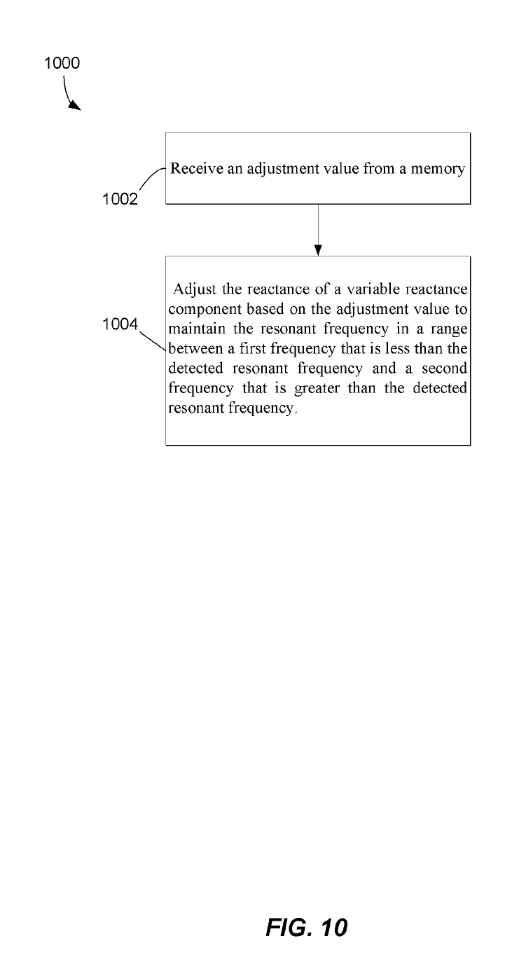

In another embodiment, upon receiving at least one calibration or recalibration request from system schedule or any other related and authorized component, the calibration device 806 may start a calibration or recalibration procedure using a look-up table approach. FIG. 10 is a flowchart of another exemplary method for adjusting the reactance of one variable reactance component using this approach. As illustrated in FIG. 10, the controller 860 may request related adjustment values from the memory 862. After it receives the requested adjustment values as shown in a block 1002, the controller 860 adjusts the reactance of a variable reactance component based on the adjustment value to maintain the resonant frequency in a range between a first frequency that is less than the detected resonant frequency and a second frequency that is greater than the detected resonant frequency as shown in a block 1004. In one embodiment, the adjustment values may be calculated beforehand and downloaded to the memory 862 during a manufacture process. In another embodiment, these adjustment values are calculated and stored in a server and later the controller 860 may download the adjustment values from the server and download them into the memory 862 before the calibration or recalibration. In another embodiment, these adjustment values may be accumulated and calculated by the controller 860. After calculated these adjustment values, the controller 860 stores them into the memory 862. The said variable reactance component can be any related adjustable component, such as the variable capacitor 809.

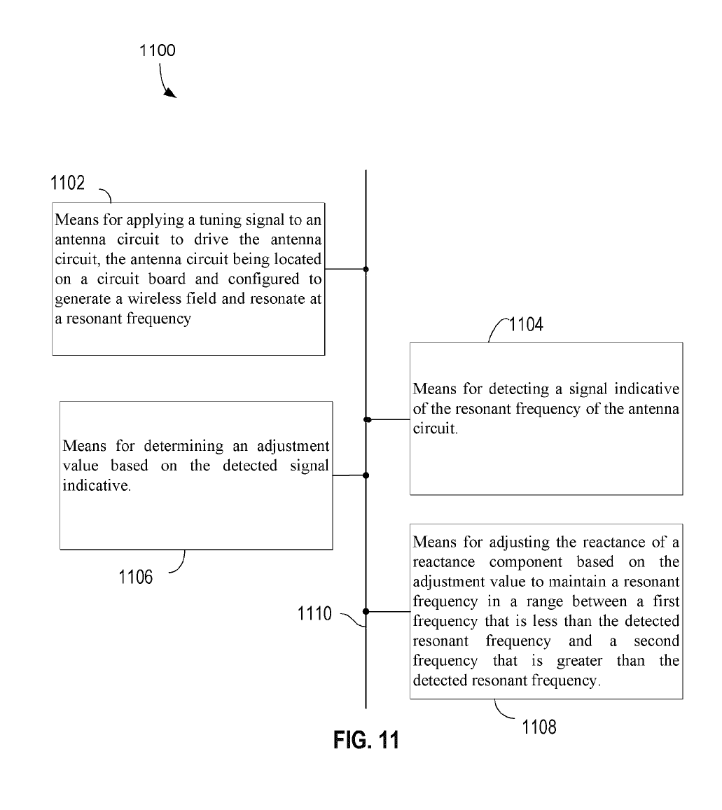

FIG. 11 is a functional block diagram of the calibration device 806 according to some implementations. In one embodiment, the means for applying a tuning signal to the antenna circuit and drive the antenna circuit as shown in the block 1102 comprises the calibration device 806, the controller 860 and the antenna circuit 700. The antenna circuit 700 may be located on the circuit board 800 and configured to generate a wireless field and resonant frequency. As shown in the block 1104, the means for detecting a signal indicative of the resonant frequency of the antenna circuit comprises the antenna circuit 700, the controller 860, a detector 876. As shown in the block 1106, the means for determining an adjustment value based on the detected signal comprises the controller 860. In addition, the means for adjusting the reactance of a variable reactance component based on the adjustment value to maintain the resonant frequency in a range between a first frequency that is less than the detected resonant frequency and a second frequency that is greater than the detected resonant frequency as shown in the block 1108 comprises the controller 860 and the variable capacitor 809.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, with reference to the exemplary method illustrated in FIG. 10, the means for adjusting the reactance of a variable reactance component comprises the memory 862, the controller 860 and the related variable capacitor 809.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An apparatus for operating a wireless device comprising:
a controller configured to apply a tuning signal to an antenna circuit to drive the antenna circuit, the antenna circuit being located on a circuit board and configured to generate a wireless field and resonate at a resonant frequency;
a detector configured to detect a signal indicative of the resonant frequency of the driven antenna circuit; and
a variable reactance component coupled to the antenna circuit, wherein the controller is configured to determine an adjustment value based on the detected signal, and wherein the controller is configured to adjust a reactance of the variable reactance component based on the adjustment value to maintain a resonant frequency in a range between a first frequency that is less than the detected resonant frequency and a second frequency that is greater than the detected resonant frequency.

2. The apparatus of claim 1, wherein the first frequency and the second frequency are centered about the detected resonant frequency.

3. The apparatus of claim 1, wherein the wireless field includes near-field communication (NFC) signals, and wherein the circuit board comprises a printed circuit board (PCB).

4. The apparatus of claim 1, wherein the antenna circuit includes a coil.

5. The apparatus of claim 1, wherein the controller is configured to apply a tuning signal during an initial device configuration routine following integration of the circuit in a portable electronic device.

6. The apparatus of claim 1, further comprising a memory configured to store initial calibration settings, and wherein the controller is configured to adjust the variable reactance component based on the initial calibration settings.

7. The apparatus of claim 1, wherein the antenna circuit includes a coil, and wherein the variable reactance component comprises a variable capacitor coupled in parallel with the coil.

8. A method for operating a wireless device comprising:
applying a tuning signal to an antenna circuit to drive the antenna circuit, the antenna circuit being located on a circuit board and configured to generate a wireless field and resonate at a resonant frequency;
detecting a signal of the resonant frequency of the antenna circuit;
determining an adjustment value based on the detected signal; and
adjusting the reactance of a variable reactance component based on the adjustment value to maintain a resonant frequency in a range between a first frequency that is less than the detected resonant frequency and a second frequency that is greater than the detected resonant frequency.

9. The method of claim 8, wherein the first frequency and the second frequency are centered about the detected resonant frequency.

10. The method of claim 8, wherein the wireless field includes near-field communication (NFC) signals, and wherein the circuit board comprises a printed circuit board (PCB).

11. The method of claim 8, wherein the antenna circuit includes a coil.

12. The method of claim 8, wherein a tuning signal is applied to the antenna circuit to drive the antenna circuit during an initial device configuration routine following integration of the circuit in a portable electronic device.

13. The method of claim 8, further comprising a memory configured to store initial calibration settings, and wherein the controller is configured to adjust the variable reactance component based on the initial calibration settings.

14. The method of claim 8, wherein the antenna circuit includes a coil, and wherein the variable reactance component comprises a variable capacitor coupled in parallel with the coil.

15. A method comprising:
receiving an adjustment value;
adjusting the reactance of a variable reactance component based on the adjustment value to maintain a resonant frequency in a range between a first frequency that is less than the detected resonant frequency and a second frequency that is greater than the detected resonant frequency.

16. The method of claim 15, wherein the first frequency and the second frequency are centered about the detected resonant frequency.

17. The method of claim 15, further comprising a memory configured to store initial calibration settings, and wherein the variable reactance component is adjusted based on the initial calibration settings.

18. The method of claim 17, wherein the memory is located on a circuit board.

19. An apparatus for operating a wireless device comprising:
means for applying a tuning signal to an antenna circuit to drive the antenna circuit, the antenna circuit being located on a circuit board and configured to generate a wireless field and resonate at a resonant frequency;
means for detecting a signal indicative of the resonant frequency of the antenna circuit;
means for determining an adjustment value based on the detected signal; and
means for adjusting the reactance of a reactance component based on the adjustment value to maintain a resonant frequency in a range between a first frequency that is less than the detected resonant frequency and a second frequency that is greater than the detected resonant frequency.

20. The apparatus of claim 19, wherein the first frequency and the second frequency are centered about the detected frequency.

21. The apparatus of claim 19, wherein the wireless field includes near-field communication (NFC) signals, and wherein the circuit board comprises a printed circuit board (PCB).

22. The apparatus of claim 19, wherein the antenna circuit includes a coil.

23. The apparatus of claim 19, wherein the controller is configured to apply a tuning signal during an initial device configuration routine following integration of the circuit in a portable electronic device.

24. The apparatus of claim 19, further comprising a memory configured to store initial calibration settings, and wherein the controller is configured to adjust the variable reactance component based on the initial calibration settings.

25. The apparatus of claim 19, wherein the antenna circuit includes a coil, and wherein the variable reactance component comprises a variable capacitor coupled in parallel with the coil.

26. An apparatus comprising:
a controller received an adjustment value from a memory; and
a variable reactance component coupled to an antenna circuit, wherein the controller is configured to adjust the reactance of the variable reactance component based on the adjustment value to maintain a resonant frequency in a range between a first frequency that is less than the detected resonant frequency and a second frequency that is greater than the detected resonant frequency.

27. The apparatus of claim 26, wherein the first frequency and the second frequency are centered about the detected resonant frequency.

28. The apparatus of claim 26, wherein the memory is configured to store initial calibration settings, and wherein the variable reactance components is adjusted based on the initial calibration settings.

29. The apparatus of claim 26, wherein a memory is located on a circuit board and stores calibration setting.

30. The apparatus of claim 26, wherein the antenna circuit includes a coil.

31. The apparatus of claim 26, wherein the controller is configured to apply a tuning signal during an initial device configuration routine following integration of the circuit in a portable electronic device.

32. The apparatus of claim 26, wherein the antenna circuit includes a coil, and wherein the variable reactance component comprises a variable capacitor coupled in parallel with the coil.

33. An apparatus comprising:
means for requesting an adjustment value from a memory;
means for adjusting the reactance of a variable reactance component based on the adjustment value to maintain a resonant frequency in a range between a first frequency that is less than the detected resonant frequency and a second frequency that is greater than the detected resonant frequency.

34. The apparatus of claim 33, wherein the memory is located on a circuit board and stores calibration setting.

35. The apparatus of claim 33, wherein the first frequency and the second frequency are centered about the detected resonant frequency.

36. The apparatus of claim 33, wherein the memory is configured to store initial calibration settings, and wherein the variable reactance component is adjusted based on the initial calibration settings.
